(19) United States
(12) Patent Application Publication
(10) Pub. No.: US 2006/0112897 A1
(43) Pub. Date: Jun. 1, 2006

(54) Storage and display furniture

(76) Inventor: Claniece Moore, St. Petersburg, FL (US)

Correspondence Address: STEPHAN A. PENDORF, P.A., PENDORF & CUTLIFF, 5111 MEMORIAL HIGHWAY, TAMPA, FL, 33634, US

(21) Appl. No.: 10/999,484

(22) Filed: Nov. 30, 2004

(51) Int. Cl. A01K 1/03

(52) U.S. Cl. 119/482

(57) ABSTRACT

A storage and display table which is an attractive piece of furniture that can be used to display or store these items; an animal crate, a pet bed, a whelping bed, and a cage. The storage and display table includes a top piece, a bottom piece and frame-like structures therebetween to support the top piece above the bottom piece. Each frame-like structures has an opening within.

### BACKGROUND OF THE INVENTION

1. Field of Invention

The present invention relates to storage and display furniture and more particularly pertains to a furniture enclosure that can be to used display or enclose home decorations; display or enclose pets; and a storage area for a variety of items. More specifically furniture that can store a pet crate, pet bedding, pet cage, and a variety of other pet accessories.

2. Description of Prior Art

The use of furniture in the form of a tables is known in the prior art. More specifically, tables heretofore devised and utilized for the purpose of storing and displaying items of home decoration or pets are known to consist mainly of a top and legs or a top, bottom and legs. Also, it is known in the art to use furniture with animals.

Examples of prior art tables are as follows: U.S. Pat. Des. 424,837 (Hazen et al.); U.S. Pat. Des 428,733 (Hazen et al.); U.S. Pat. Des. 429,915 (Hazen et al.); U.S. Pat. Des. 432,813 (Hazen et al.); U.S. Pat. Des. (Hazen et al.) 437,507 and U.S. Pat. Des. 490,254 (Stanton).

Further, the prior art teaches various types of housing for domestic animals, such as the prior art animal furniture set out below.

The BowHaus Pet Crate, constructed of steel, aluminum and PVC. The crate has a round den-like shape that includes a top, lid and a sliding picket door. The wall of the BowHaus crate is vented and the top can functions as a table.

U.S. Pat. No. 3,872,832 (Quinn) discloses cat furniture, which includes a pair of front doors covering the front of a generally rectangular structure. A litter box is included in the furniture. An end panel is removable and may be attached to either end or side of the unit. The other end or side, which is open, provides access to the interior of the structure for the cat.

U.S. Pat. No. 4,021,975 (Calkins) discloses a pet house connected to the interior of a residence. The pet house structure is disposed on the outside of the residence and is connected to the residence by a tunnel. Within the pet house is a litter box and “living” quarters for the cat. The structure is divided into two portions, a litter box portion and a carpeted “living” portion.

U.S. Pat. No. 4,732,111 (Runion) discloses a housing in which there is a disposable litter box. The litter box includes a tray and a plastic sleeve, which encloses the litter box, when the litter box is withdrawn from the housing.

U.S. Pat. No. 4,760,816 (Rhodes) discloses a litter box, which includes a pair of fixed, flat ends and an accordion pleated wall between the two ends. One end includes an opening through which a cat goes into and out of the litter box. The litter box may be stored in its folded condition and then expanded for use.

U.S. Pat. No. 5,184,568 (Healey) discloses cat furniture in a configuration of a chair. The front of the chair includes an opening and a litter box tray is disposed within the unit.

U.S. Pat. No. 5,184,575 (Reinaltz) discloses an automatic cat litter box, which includes a generally rectangular housing. An opening in the housing allows the cat to go into and out of the housing. Also included in the apparatus is an automatic litter box cleaning and replenishing system.

U.S. Pat. No. 5,282,439 (Oaks) discloses a multi-purpose pet enclosure that is comprised of a bottom wall, a vertical wall and an access opening in the front. Specifically, the enclosure includes a body portion that forma a chamber defined by a bottom wall and a vertical wall. The vertical wall includes a front portion that has an access opening for providing access to the chamber. Included is a panel adapted to be removably inserted in the access opening, and a lid to fit over the top of the body portion.

U.S. Pat. No. 5,778,822 (Griffin et al.) discloses a pet litter container having a covering defines an interior space. A door opening in the covering allows for pet ingress and egress. A plurality of ventilation openings are provided in the covering.

U.S. Pat. No. 6,286,458 (Rawson) discloses an animal housing furniture apparatus for a domestic animal. Within the housing or enclosure is a shelf support may be used to hold the litter box or the litter box may be disposed below the shelf support. A flap covers an opening at one end of the enclosure and the animal moves into and out of the enclosure through the flap covered opening. Also within the enclosure is a storage area for items, which pertain to the animal.

U.S. Pat. App. No. 2002/0152969 Grigsby et al. discloses a pet enclosure, which is a piece of furniture. The encloure includes a decorative exterior cabinet, an upper ventilation structure, a light and camera. The cabinet of Grigsby et al. has a base and at least one upstanding wall to define a generally circumferentially enclosed sleeping chamber. The upstanding wall has an entrance opening for pet the pet to enter and exit. The cabinet has a top panel and a bottom panel that interconnects with the upstanding wall. Double doors are used adjacent the entrance opening.

### BRIEF SUMMARY OF THE INVENTION

The present invention is a piece of storage and display furniture in the form of a table that has multiple functions within a novel and simple construction.

After extensive study and testing of various table designs, the present inventor discovered that the present invention allows for optimal usage.

Accordingly, a primary function of the storage and display furniture is to provide a novel place to store or display house hold items or to store or display domestic pets, which is an alternative to the standard use for a piece of furniture. As such, the general purpose of the present invention, will be described subsequently in greater detail.

To attain this, the present invention essentially comprises, a table like structure that has a top piece, a bottom piece and at least four frame-like structures in combination to form the invention. The four frame-like structures are fastened between the top and bottom piece to support the top piece. In the preferred embodiment, the top piece is supported an equal distance above the bottom piece. One of each of the four frame-like structures is fastened to two of the four frame-like structures along parallel side edges. Each of the four frame-like structures is fastened to the bottom piece. Further, each frame-like structures has an opening therein.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions in so far as they do not depart from the spirit and scope of the present invention.

It is therefore an object of the present invention to provide a new use for a piece of furniture which is an improvement over the prior art furniture in that the furniture is a structure that can be used to store and display items under the top piece as well as on the top piece.

Another object of the present invention is to provide a new and improved place to store and display pet housing, or confine pets that has the configuration of custom furniture that may be placed anywhere in the home.

A further object of the present invention is to provide a piece of furniture that is table like with side walls that are frame-like to allow the space between the top piece and the bottom piece to be enclosed or accessible by the use of removable panels and a removable door.

An even further object of the present invention is to provide a storage and display furniture which is susceptible of a low cost of manufacture with regard to both materials and labor, and which accordingly is then susceptible of low prices of sale to the consuming public, thereby making such storage and display furniture economically available to the buying public.

Still another object of the present invention is to provide a piece of furniture that has a bottom and can be accessed at the top piece when the panels and door are fastened to the frame-like structures.

These together with other objects of the invention, along with the various features of novelty which characterize the invention, are pointed out with particularity in the claims annexed to and forming a part of this disclosure. For a better understanding of the invention, it operating advantages and the specific objects attained by its uses, reference should be had to the accompanying drawings and descriptive matter in which there is illustrated the preferred embodiments of the invention.

### BRIEF DESCRIPTION OF THE DRAWINGS

The invention will be better understood and objects other than those set forth above will become apparent when consideration is give to the following detailed description thereof. Such description makes reference to the annexed drawings wherein:

FIG. 1 is a perspective illustration of the preferred embodiment of the storage display furniture in the form of a table in accordance with the principles of the present invention.

FIG. 2 is perspective view of the apparatus of the present invention with the panels removed.

FIG. 3 is a perspective view of the apparatus of the present invention having an animal crate therein.

FIG. 4 is cross-sectional side view of the frame-like structure of the present invention taken at A-A of FIG. 4a.

FIG. 4a is frontal view of one of the frame-like structures of the present invention.

FIG. 5 is an inside section view of the lip clip fastened to the inside wall of one of the frame-like structures.

FIG. 6 is a cross-sectional side view of FIG. 5 taken along line A-A of FIG. 5.

FIG. 7 is an inside section view of the flush clip fastened to the inside wall of one of the frame-like structures.

FIG. 8 is a cross-sectional side view of FIG. 7 taken along line A-A of FIG. 7.

FIG. 9 is a top plan view of the apparatus of the present invention.

FIG. 10 is a side view of a frame-like structure of the apparatus of FIG. 1.

FIG. 11 is an enlarged cut-out view of the door hingedly fastened to the inside wall of one of the frame-like structures.

FIG. 12 is a sectional view of the inside door and the adjacent frame-like structure showing the hinge and panel clips.

FIG. 13 is a side view of the apparatus without the panels and a single door.

FIG. 14 is a frontal view of the apparatus showing double doors and an interior shelf.

Similar reference characters refer to similar parts through the several views of the drawings.

### DETAILED DESCRIPTION OF THE INVENTION

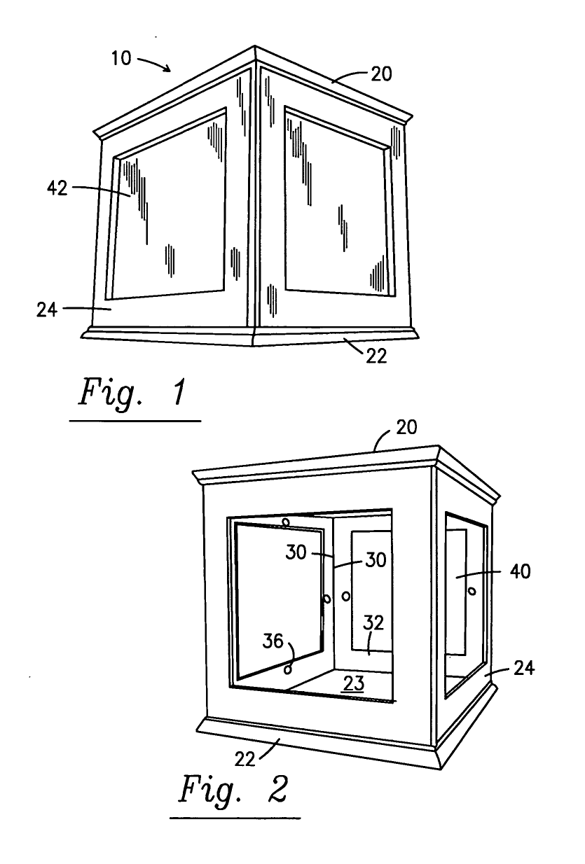

With reference now to the drawings, and in particular to FIG. 1 thereof, a storage and display furniture in the form of a table embodying the principles and concepts of the present invention and generally designated by the reference numeral 10 will be described.

The present invention, storage and display table, is comprised of a plurality of components. Such components in their broadest context include a top piece, a bottom piece and frame-like structures. Such components are individually configured and correlated with respect to each other so as to attain the desired objective.

More specifically, the present invention of FIG. 1, includes a top piece 20, a bottom piece 22 and a plurality of frame-like structures 24 which supports the top piece above the bottom piece. Specifically, the frame-like structures support the top piece an equal distance above the bottom piece. The top and bottom piece of the storage and display table of the present invention each has a top surface covered with a water-repellent material. The water-repellent material is on the interior surface 23 (floor) of the bottom piece and one or more surfaces of the top piece. The present invention is operable with three or four frame-like structures. Preferably, four frame-like structures are used to support the top piece above the bottom piece.

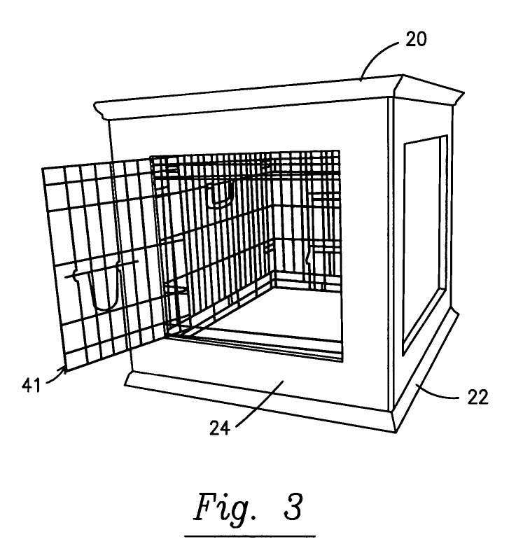

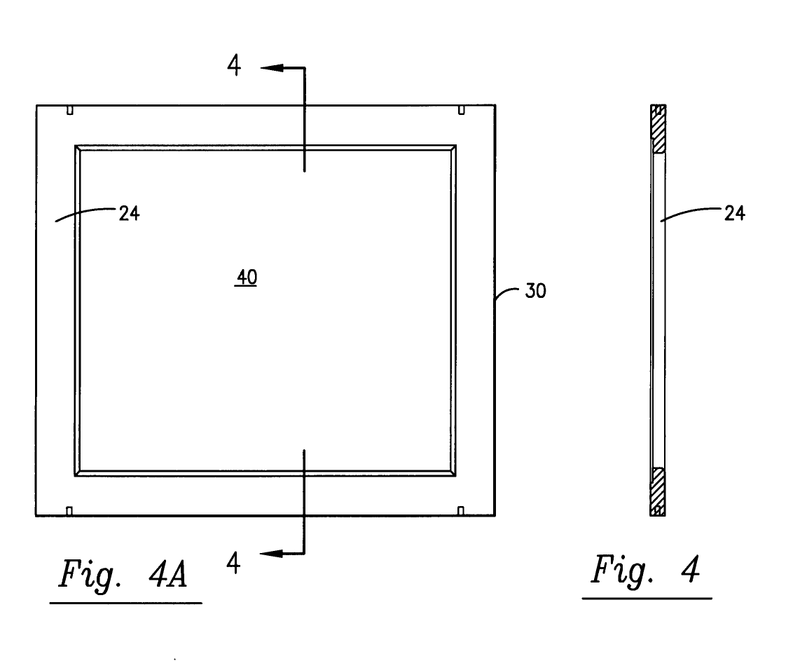

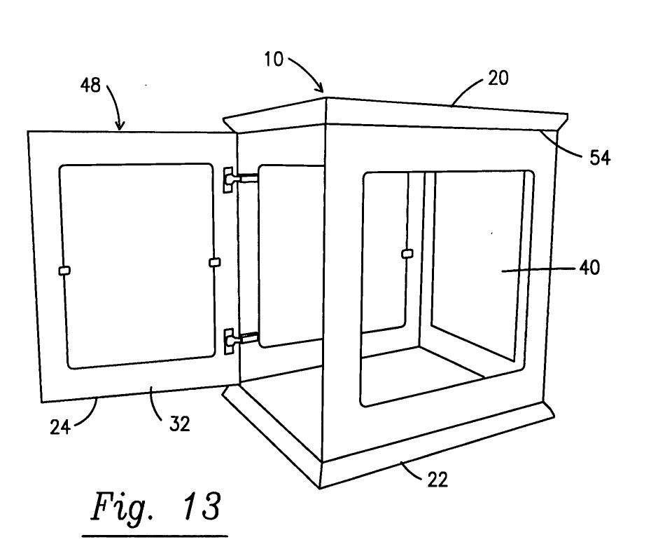

Further, as shown in FIG. 4a, each frame-like structure has side edges 30. Each side edge has a corresponding side edge spaced therefrom and parallel thereto. As best illustrated in FIGS. 2 and 13, one of each of the frame-like structures has two of the frame-like structures fastened to parallel side edges 30. When fastened to a common frame-like structure the side edges the two fastened frame-like structures are parallel one to the other. Also, each of the frame-like structures is fastened to the bottom piece 23, as shown in FIGS. 1, 2, 3, 13 and 14.

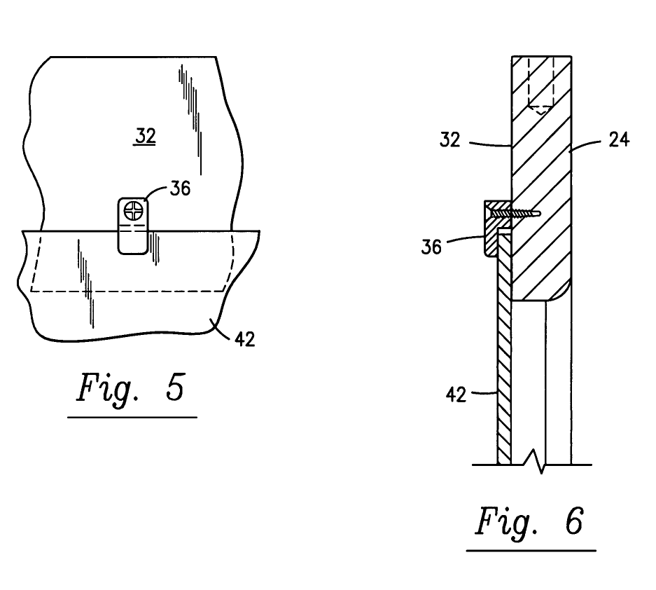

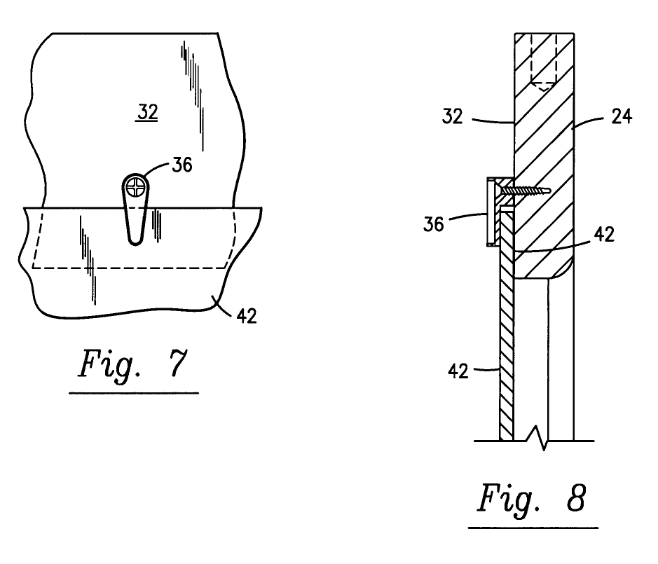

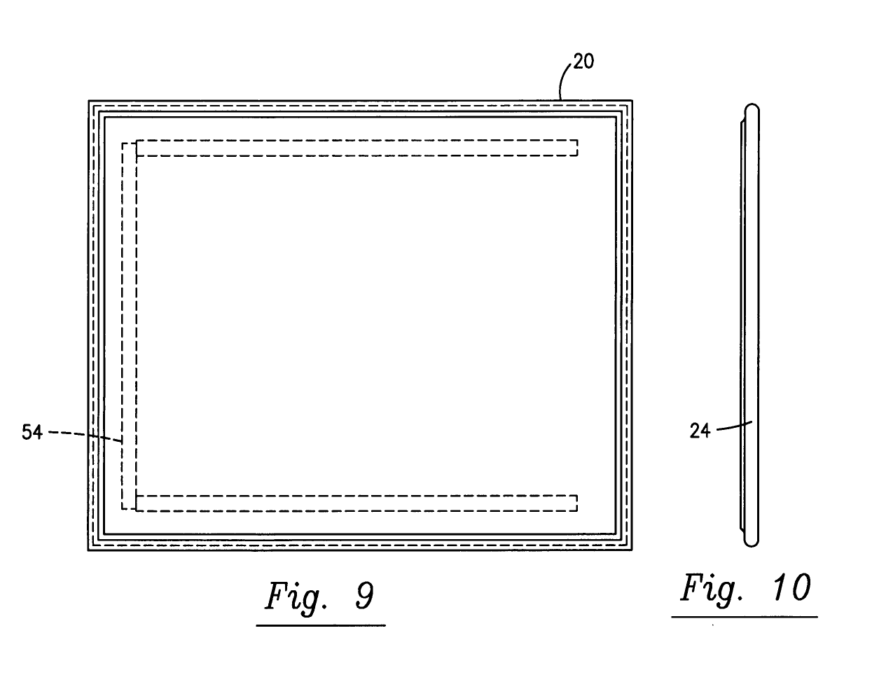

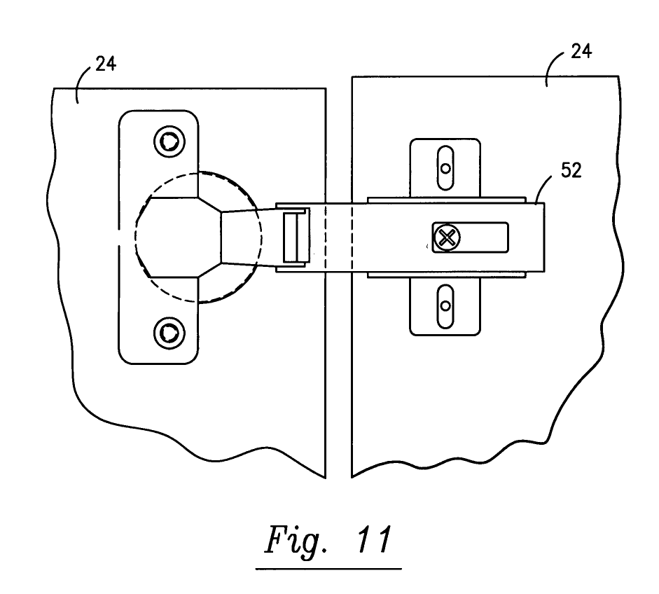

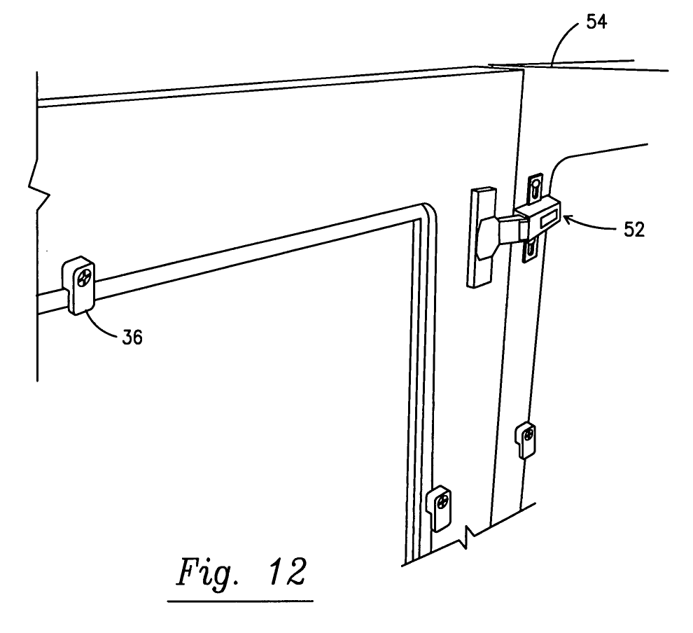

Coupled to an inside wall 32 of each of the frame-like structures is at least one panel clip 36, as seen in FIGS. 2, 5, 6, 7 and 8. Preferably, a plurality of panel clips are selectively mounted to the inside wall 32 of each of the frame-like structures. The panel clips may be any type of clip that fastens to a first object for the purpose of releasable holding another object in a mounted position with on or about the first object. In the present invention, both flush clips and lip clips may be used.

Each of the frame-like structures, of the storage and display furniture of FIG. 4a has an opening 40. Each opening of the frame-like structures can be identical to the opening of any one of the other frame-like structures. Also, each opening of the frame-like structures can have a variety of shapes to include but is not limited to oval, circle, star, or heart shape. Connecting the top and bottom pieces with the frame-like structures creates a display area between the top piece and the bottom piece. Further, the display area is sized and shaped to have a variety of items positioned therein. Some of the items a user my place within the display area are an animal crate 41, a litter box, a pet bed, a whelping bed, and a cage.

To create a storage area within the storage and display furniture of FIG. 1, a plurality of panels 42 are included. Each panel is sized and shaped to be positioned over the openings of the frame-like structure. The panels may be seated within the opening of the frame-like structure, when the frame-like structure has an interior peripheral shelf 44, as shown in FIG. 8, extending about the circumference of the inside wall 32. Further, the panels may rest juxtapose the inside wall. One of the plurality of panels is secured over the opening 40 and juxtapose the inside wall, as shown in FIG. 6, of any one of the frame-like structures, with at least one of the plurality of panel clips 36.

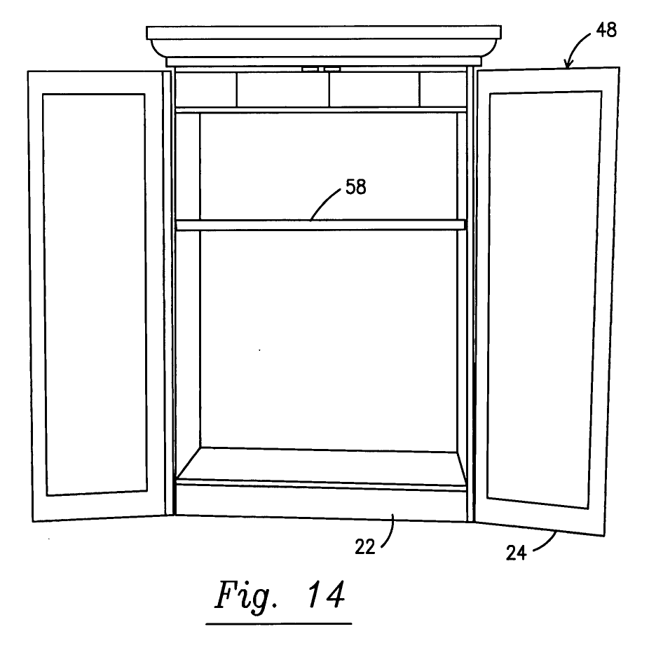

As shown in FIGS. 13 and 14, the storage and display furniture of the present invention may include a door 48. The door can be a single door or a double door to enhance the enclosure the storage area. The door/doors are fastened to one of the frame-like structures. The door can be one of the plurality of frame-like structures 24, which provides a single door, as in FIG. 13. In the alternative the door can be one of the panels. Further, the double doors can be used to enclose the apparatus. The double doors each being a frame-like structure as shown in FIG. 14. A hinge 52 is used for opening and closing of the door. An enclosed storage space is created when one of each of the openings is covered with a panel and one of the openings has the door in a closed position.

When the apparatus of the present invention has the storage area created, a plurality of items may be placed within. Examples of these items are; an animal crate 41, a litter box, a pet bed, a whelping bed, and a cage.

The top piece of the storage and display furniture, of FIG. 10 may be hingedly coupled to an upper edge 54 of one of the frame-like structures. Having the top piece attached where it can open and close, allows the user to access storage area from the top as an alternative to side access of the storage area of the present invention.

As depicted in FIG. 14, the storage and display furniture may include an adjustable shelf 58. When a shelf is placed within the storage/display area, each of the frame-like structures would include on its interior wall a means to support the shelf or shelves.

With respect to the above description then, it is to be realized that the optimum dimensional relationships for the parts of the invention, to include variations in size, material, shape, form, function and manner of operation, assembly and sue, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. It is not intended to be exhaustive or to limit the invention to the precise forms disclosed. Obvious modifications or variations are possible in light of the above teachings. The embodiments discussed were chose and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, equitably entitled.

What I claims as my invention is:

1. A storage and display furniture comprising:
a top piece;
a bottom piece;
a plurality of frame-like structures therebetween for supporting the top piece above the bottom piece, one of each of the plurality of frame-like structures being fastened to two of the plurality of frame-like structures along parallel side edges, with each of the plurality of frame-like structures being fastened to the bottom piece; and
one or more panel clips, with at least one of the panel clips being selectively mounted to an inside wall of each of the plurality of frame-like structures.

2. The storage and display furniture as set forth in claim 1, wherein each of the plurality of frame-like structures has an opening therein for creating a display area between the top piece and the bottom piece.

3. The storage and display furniture as set forth in claim 2, further comprising one or more panels wherein each of said panels is sized and shaped for positioning over the openings of the frame-like structure.

4. The storage and display furniture as set forth in claim 3, wherein one of the one or more panels is secured over the opening and juxtapose the inside wall of any one of the frame-like structures with at least one of the panel clips.

5. The storage and display furniture as set forth in claim 4, further includes a door that is hingedly fastened to a side edge of one of the plurality of frame-like structures for opening and closing.

6. The storage and display furniture as set forth in claim 5, having a storage space is created when each one of the openings are covered with a panel and one of the openings has the door in a closed position.

7. The storage and display furniture as set forth in claim 1, further comprising an animal crate positioned within the interior display area.

8. The storage and display furniture as set forth in claim 1, further comprising a pet bed positioned within the interior display area.

9. The storage and display furniture as set forth in claim 1, further comprising a whelping bed positioned within the interior display area.

10. The storage and display furniture as set forth in claim 1, further comprising a cage positioned within the interior display area.

11. The storage and display furniture as set forth in claim 1, wherein the top piece is hingedly coupled to an upper edge of one of the plurality of frame-like structures.

12. The storage and display furniture as set forth in claim 6, further includes an animal crate within the storage space.

13. The storage and display furniture as forth in claim 6, further includes a pet bed within the storage space.

14. The storage and display furniture as set forth in claim 6, further includes a whelping bed within the storage space.

15. The storage and display furniture as set forth in claim 6, further includes a cage within the storage space.

16. The storage and display furniture as set forth in claim 5, wherein the top piece is hingedly coupled to an upper edge of one of the frame-like structures.

17. A storage and display furniture comprising:
a top piece;
a bottom piece; and
a plurality of frame-like structures therebetween for supporting the top piece above the bottom piece, one of each of the plurality of frame-like structures being fastened to two of the plurality of frame-like structures along parallel side edges, with each of the plurality of frame-like structures being fastened to the,bottom piece.

18. The storage and display furniture as set forth in claim 17, further comprising one or more panel clips, with at least one of the panel clips being selectively mounted to an inside wall of each of the plurality of frame-like structures.

19. The storage and display furniture as set forth in claim 17, wherein each of the plurality of frame-like structures has an opening therein for creating an interior display area between the top piece and the bottom piece.

20. The storage and display furniture as set forth in claim 19, further comprising one or more panels wherein each of said panels is sized and shaped for positioning over the openings of the frame-like structure, and secured over the opening and juxtapose the inside wall of any one of the frame-like structures with at least one of the panel clips.
